(19) United States
(12) Patent Application Publication
(10) Pub. No.: US 2026/0208319 A1
(43) Pub. Date: Jul. 23, 2026

(54) NON-CONTACT PAD CLEANING APPARATUS

(71) Applicant: EBARA CORPORATION, Tokyo (JP)

(72) Inventors: Erina BABA, Tokyo (JP); Masayoshi ITO, Tokyo (JP); Kensho YAMAKAWA, Tokyo (JP)

(21) Appl. No.: 19/421,449

(22) Filed: Dec. 16, 2025

(30) Foreign Application Priority Data
Dec. 20, 2024 (JP) 2024-225181

(51) Int. Cl. B24B 53/017; B08B 3/02; B08B 5/02; B08B 9/00; B08B 13/00

(52) U.S. Cl. CPC B24B 53/017; B08B 3/022; B08B 3/024; B08B 5/023; B08B 9/00; B08B 13/00

(57) ABSTRACT

A non-contact pad cleaning apparatus that does not cause a liquid to stay on a polishing surface of a polishing pad and capable of improving a cleaning effect for the polishing surface is disclosed. The polishing-surface cleaning device includes a plurality of two-fluid nozzles each configured to eject a two-fluid jet, and an upstream-side nozzle cover and a downstream-side nozzle cover. The upstream-side nozzle cover is arranged upstream of the plurality of two-fluid nozzles in a rotation direction of the polishing pad, and the downstream-side nozzle cover is arranged downstream of the plurality of two-fluid nozzles in the rotation direction of the polishing pad. A distance from the polishing surface to a lower end of the upstream-side nozzle cover is larger than a distance from the polishing surface to a lower end of the downstream-side nozzle cover.

### CROSS REFERENCE TO RELATED APPLICATION

This document claims priority to Japanese Patent Application No. 2024-225181 filed December 20, 2024, the entire contents of which are hereby incorporated by reference.

### BACKGROUND

A polishing apparatus is a device for polishing a workpiece, such as a wafer, a substrate, or an interconnect panel for use in manufacturing of semiconductor devices. The surface of the workpiece is polished by being brought into sliding contact with a polishing surface of a polishing pad in the presence of slurry. In order to maintain polishing performance of the polishing pad, dressing of the polishing surface of the polishing pad is performed using a dresser. Specifically, the dresser scrapes off the polishing surface of the polishing pad slightly by bringing a dressing surface, to which abrasive grains, such as diamond particles, are fixed, into sliding contact with the polishing surface of the polishing pad, thereby regenerating the polishing surface of the polishing pad.

Minute holes are formed in the polishing surface of the polishing pad. Foreign matters, such as polishing debris of the workpiece, abrasive grains contained in the slurry, and debris of the polishing pad, accumulate in these holes. Therefore, in order to remove the foreign matters from the holes, a jet flow of pure water is applied to the polishing surface from an atomizer while the polishing pad is rotating to thereby wash away the foreign matters from the polishing pad with the pure water. Since the pure water collides with the polishing surface of the polishing pad vigorously, a scattering prevention cover is attached to the atomizer in order to prevent scattering of the pure water (see Japanese laid-open patent publication No. 2016-97465).

However, the pure water dispensed from the atomizer to the polishing surface of the polishing pad is dragged by the polishing surface of the rotating polishing pad and collides with the jet flow of the pure water, forming a water film on the polishing surface. This water film is dammed by the jet flow of the pure water and the scattering prevention cover, and the thickness of the water film increases. The water film on the polishing surface may inhibit the jet flow of the pure water, directed from the atomizer to the polishing surface, from impinging on the polishing surface, potentially reducing a cleaning effect of the polishing surface.

### SUMMARY

Therefore, there is provided a non-contact pad cleaning apparatus that does not cause a liquid to stay on a polishing surface of a polishing pad and capable of improving the cleaning effect of the polishing surface.

Embodiments, which will be described below, relate to a non-contact pad cleaning apparatus for cleaning a polishing surface of a polishing pad used for polishing of a workpiece, such as a wafer, a substrate, or an interconnect panel, with a fluid.

In an embodiment, there is provided a non-contact pad cleaning apparatus for cleaning a polishing surface of a polishing pad for polishing a workpiece in a non-contact manner, comprising: a rotary table configured to rotate the polishing pad; a polishing-surface cleaning device having a plurality of two-fluid nozzles each configured to emit a two-fluid jet toward the polishing surface of the polishing pad; and a liquid supply line and a gas supply line coupled to the plurality of two-fluid nozzles, wherein the polishing-surface cleaning device comprises: the plurality of two-fluid nozzles having a plurality of ejection ports, respectively, the plurality of ejection ports being configured to emit the two-fluid jet; a nozzle carrier holding the plurality of two-fluid nozzles; and an upstream-side nozzle cover and a downstream-side nozzle cover fixed to the nozzle carrier, wherein the plurality of ejection ports are arranged at different distances from a center of the polishing pad, the upstream-side nozzle cover is arranged upstream of the plurality of two-fluid nozzles in a rotation direction of the polishing pad, the downstream-side nozzle cover is arranged downstream of the plurality of two-fluid nozzles in the rotation direction of the polishing pad, and a distance from the polishing surface to a lower end of the upstream-side nozzle cover is larger than a distance from the polishing surface to a lower end of the downstream-side nozzle cover.

In an embodiment, the distance from the polishing surface to the lower end of the upstream-side nozzle cover is in a range of 10 mm to 20 mm.

In an embodiment, the distance from the polishing surface to the lower end of the downstream-side nozzle cover is in a range of 3 mm to 9 mm.

In an embodiment, an outer end portion of the upstream-side nozzle cover and an outer end portion of the downstream-side nozzle cover are located radially outward of a peripheral edge of the polishing pad.

In an embodiment, the polishing-surface cleaning device further includes an outer cover coupled to an outer end portion of the upstream-side nozzle cover and an outer end portion of the downstream-side nozzle cover.

In an embodiment, the polishing-surface cleaning device further includes an inner cover coupled to an inner end portion of the upstream-side nozzle cover and an inner end portion of the downstream-side nozzle cover.

In an embodiment, a width of the upstream-side nozzle cover in a direction perpendicular to a longitudinal direction of the nozzle carrier is larger than a width of the downstream-side nozzle cover in the direction perpendicular to the longitudinal direction of the nozzle carrier.

In an embodiment, each of the plurality of ejection ports is parallel to a longitudinal direction of the nozzle carrier.

In an embodiment, the non-contact pad cleaning apparatus further comprises a nozzle oscillation mechanism configured to oscillate the polishing-surface cleaning device above the polishing pad.

In an embodiment, the non-contact pad cleaning apparatus further comprises an operation controller configured to control an operation of the nozzle oscillation mechanism, wherein the operation controller is configured to instruct the nozzle oscillation mechanism to oscillate the polishing-surface cleaning device above the polishing pad at a preset oscillation angle, and the preset oscillation angle is changeable.

In an embodiment, the upstream-side nozzle cover is inclined downward toward an upstream side in the rotation direction of the rotary table, and the downstream-side nozzle cover is inclined downward toward a downstream side in the rotation direction of the rotary table.

In an embodiment, the plurality of ejection ports are inclined at different angles with respect to a longitudinal direction of the nozzle carrier.

In an embodiment, the plurality of ejection ports are located on a plurality of straight lines, respectively, passing through the center of the polishing pad when viewed from above the polishing pad.

In an embodiment, the non-contact pad cleaning apparatus further comprises a cover-inner-surface cleaning device configured to clean inner surfaces of the upstream-side nozzle cover and the downstream-side nozzle cover.

In an embodiment, the non-contact pad cleaning apparatus further comprises a cover-outer-surface cleaning device configured to clean outer surfaces of the upstream-side nozzle cover and the downstream-side nozzle cover.

The two-fluid jet emitted from the two-fluid nozzle collides with the polishing surface of the polishing pad, and thereafter, the liquid in the two fluids flows to the upstream side and the downstream side on the polishing surface. A part of the liquid flowing to the upstream side is dragged by the polishing surface of the rotating polishing pad to flow backward, and is dammed by the two-fluid jet emitted from the two-fluid nozzle. As a result, a liquid film is formed between the two-fluid jet and the lower end of the upstream-side nozzle cover. Since the distance between the lower end of the upstream-side nozzle cover and the polishing surface is large, the liquid film is unlikely to come into contact with the lower end of the upstream-side nozzle cover. Therefore, the liquid flowing to the upstream side can pass through a gap between the lower end of the upstream-side nozzle cover and the polishing surface. A part of the liquid film is carried by the liquid flowing to the upstream side and flows out through the gap between the lower end of the upstream-side nozzle cover and the polishing surface. Another part of the liquid film flows radially outward of the polishing pad and is discharged from the polishing surface. Therefore, the thickness of the liquid film does not become large. As a result, the two-fluid jet emitted from the two-fluid nozzle collides with the polishing surface of the polishing pad without being inhibited by the liquid film, and can clean the polishing surface.

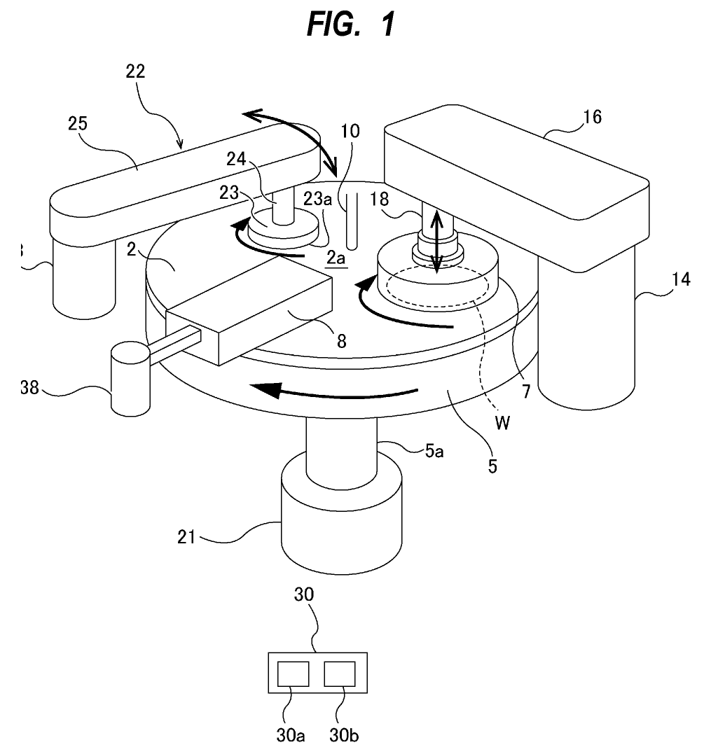

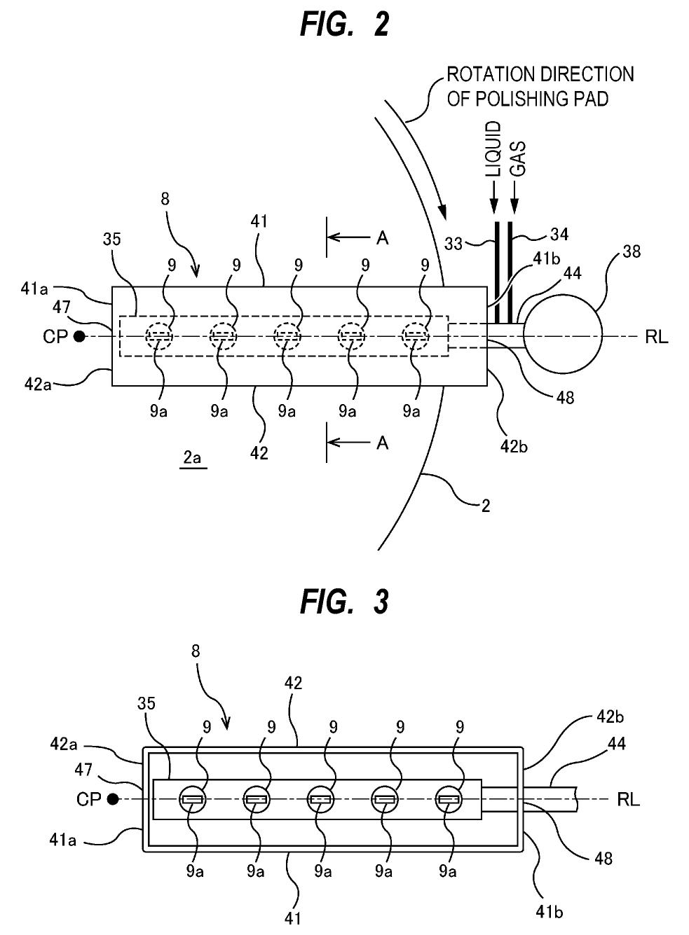

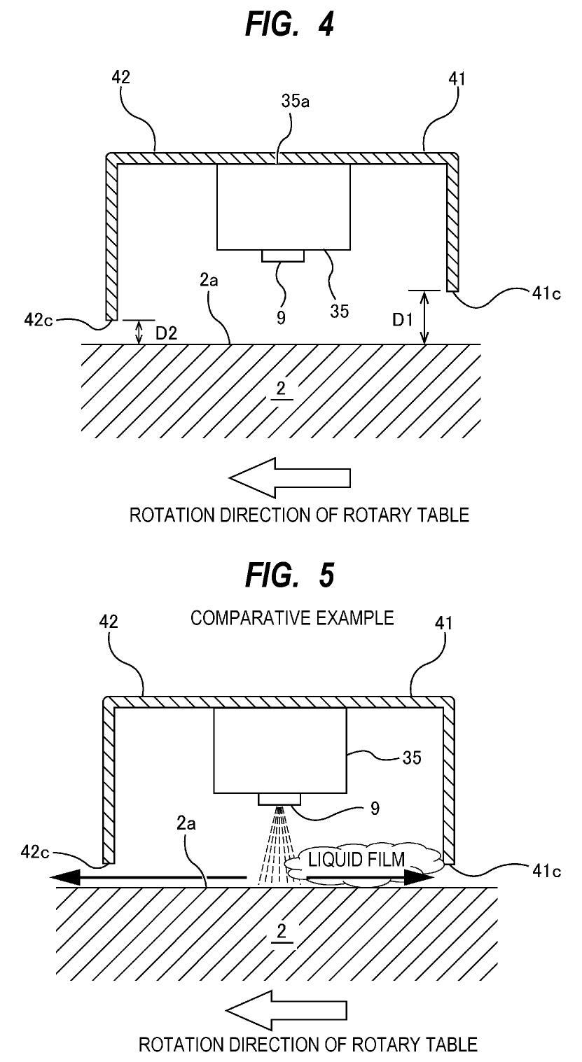

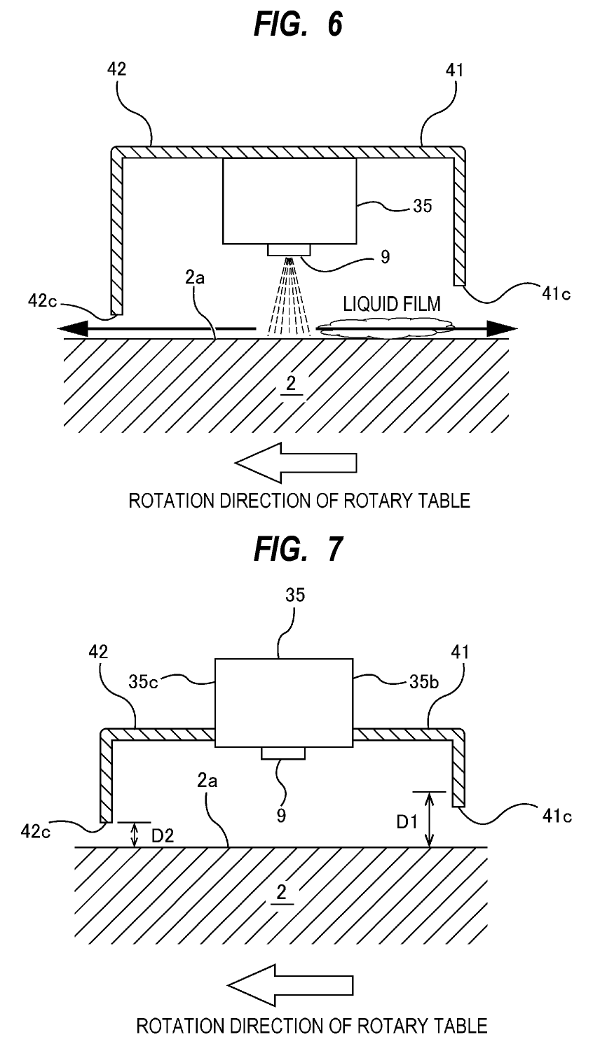

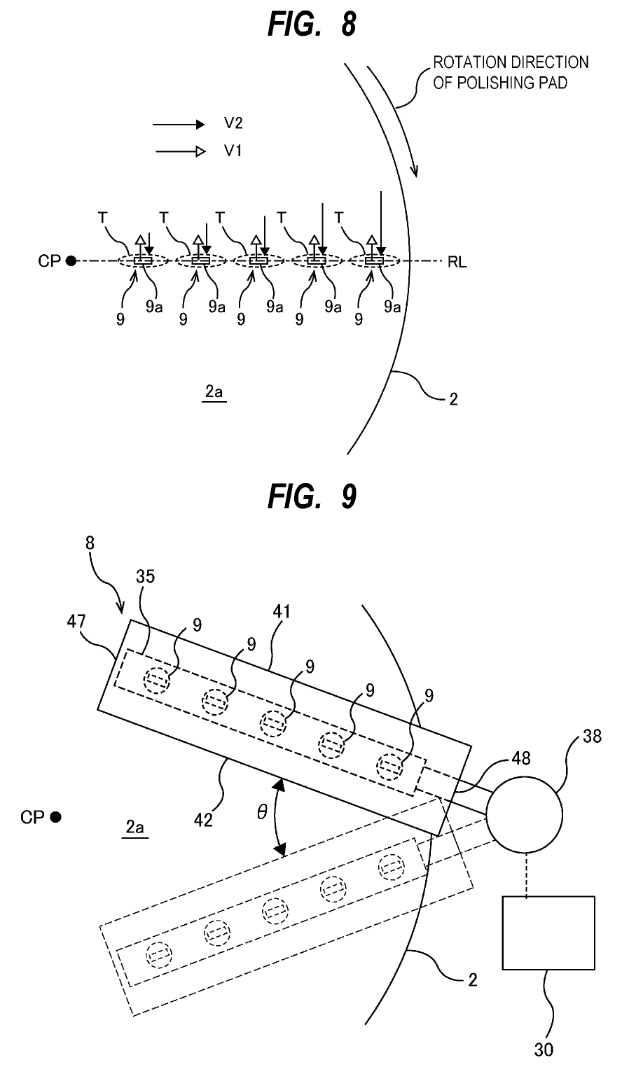

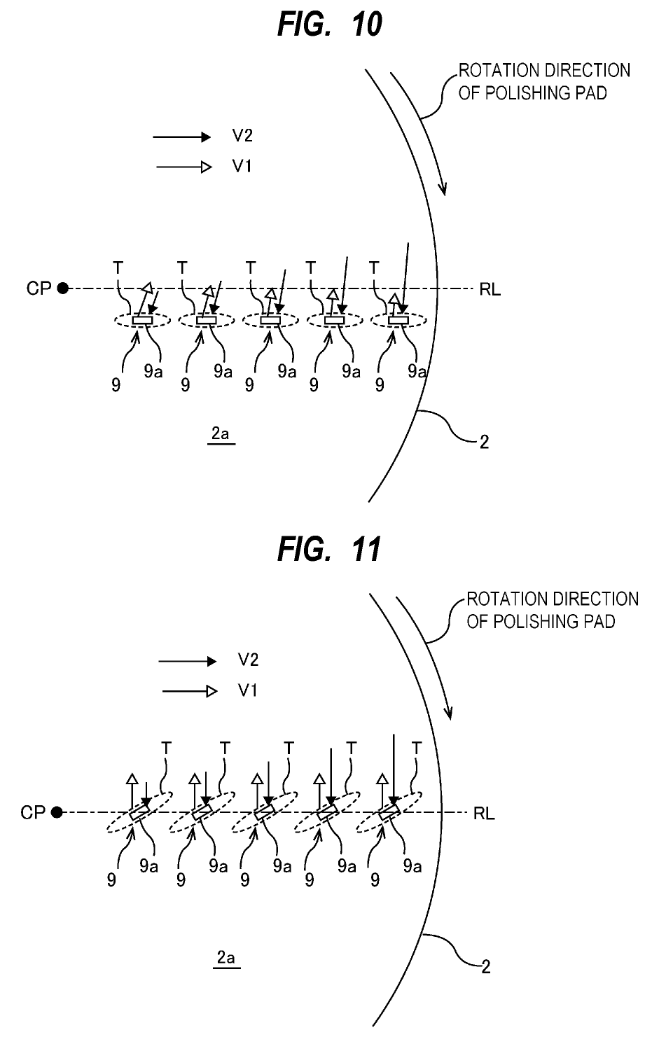

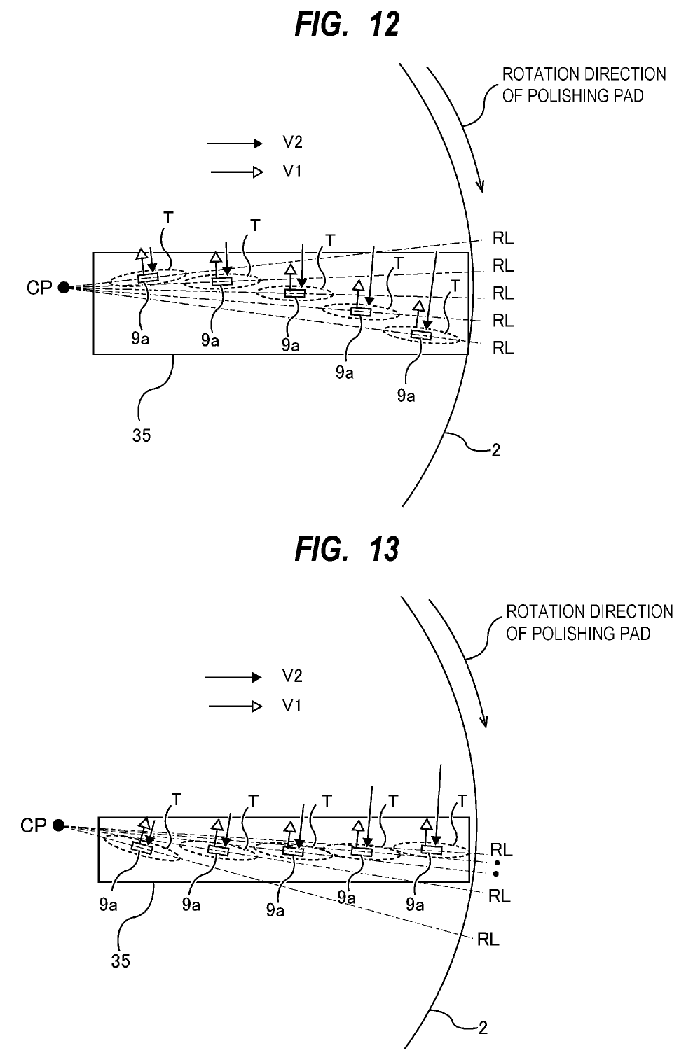

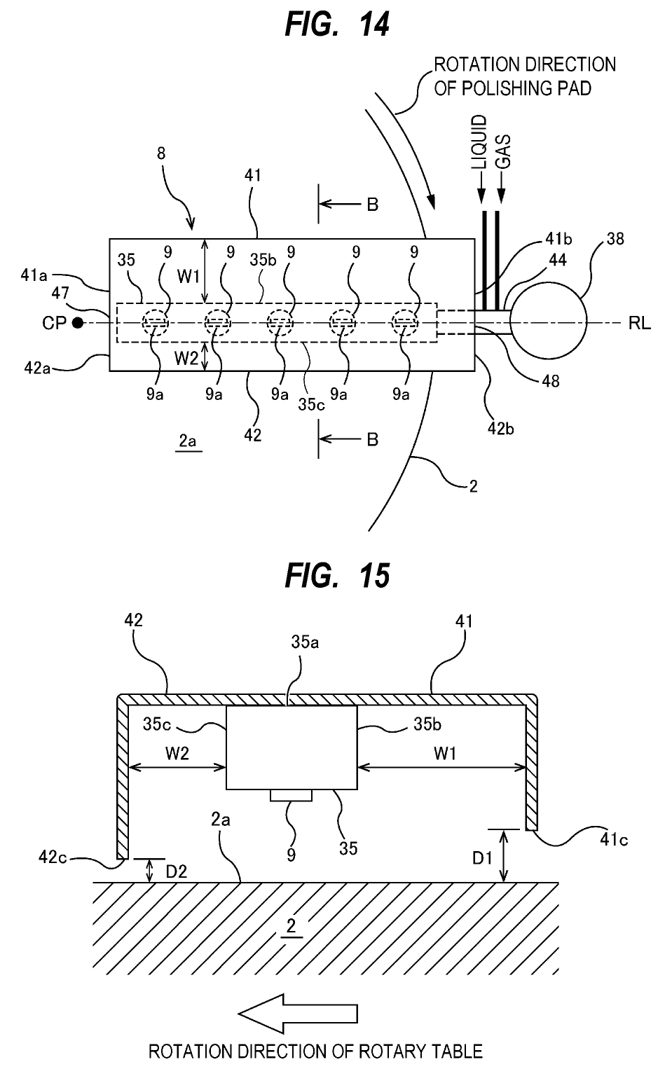

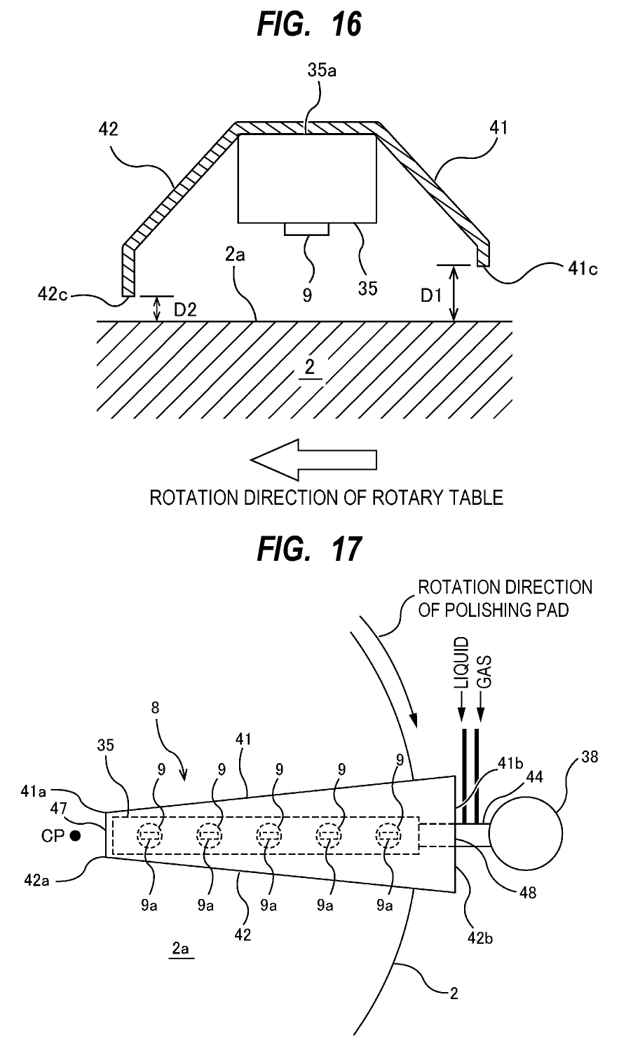

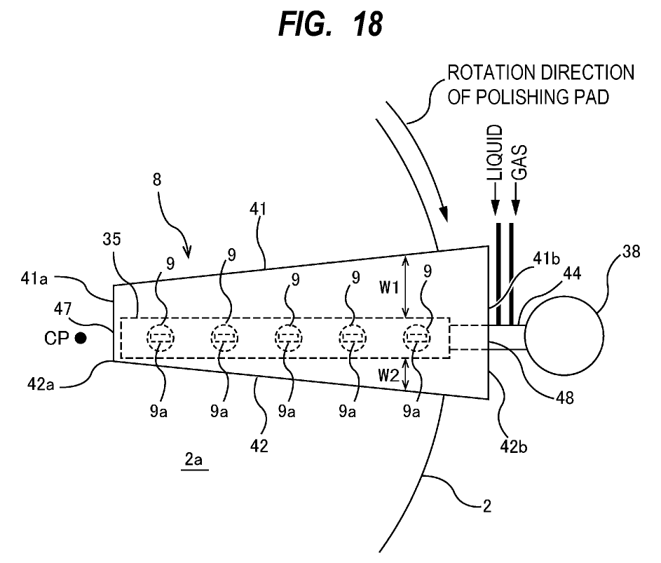

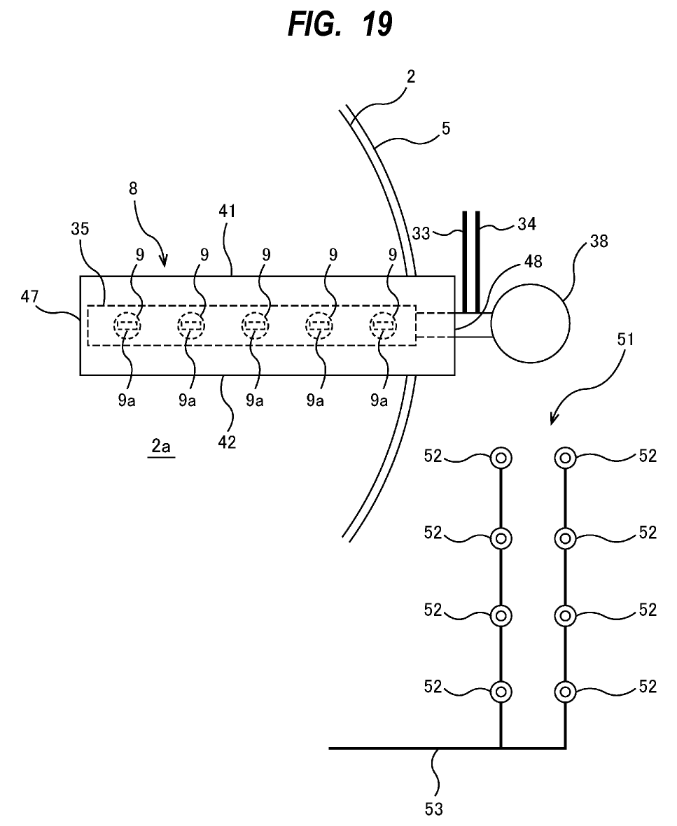

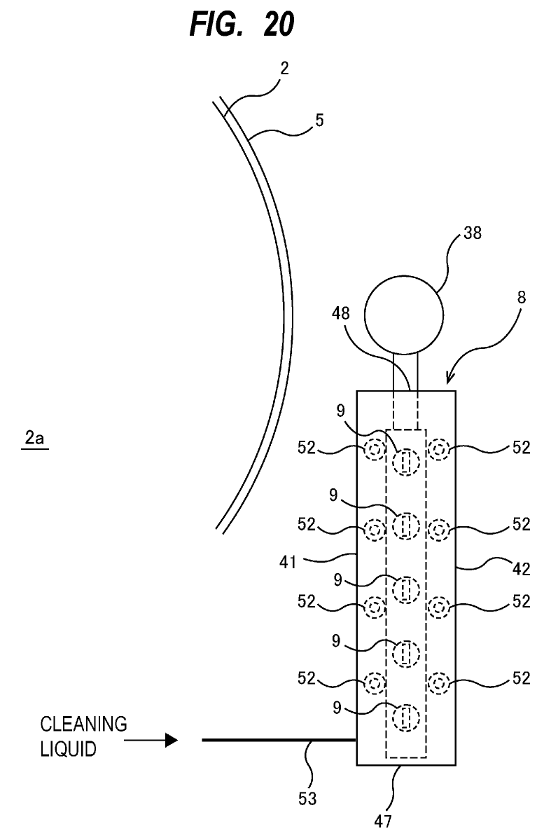

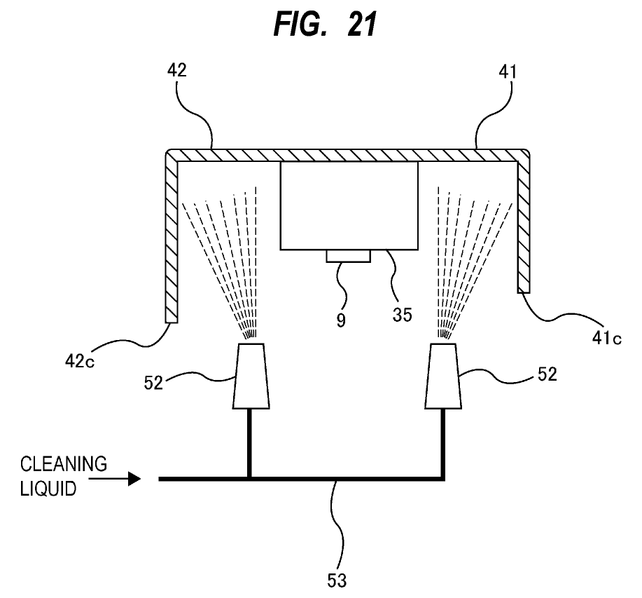

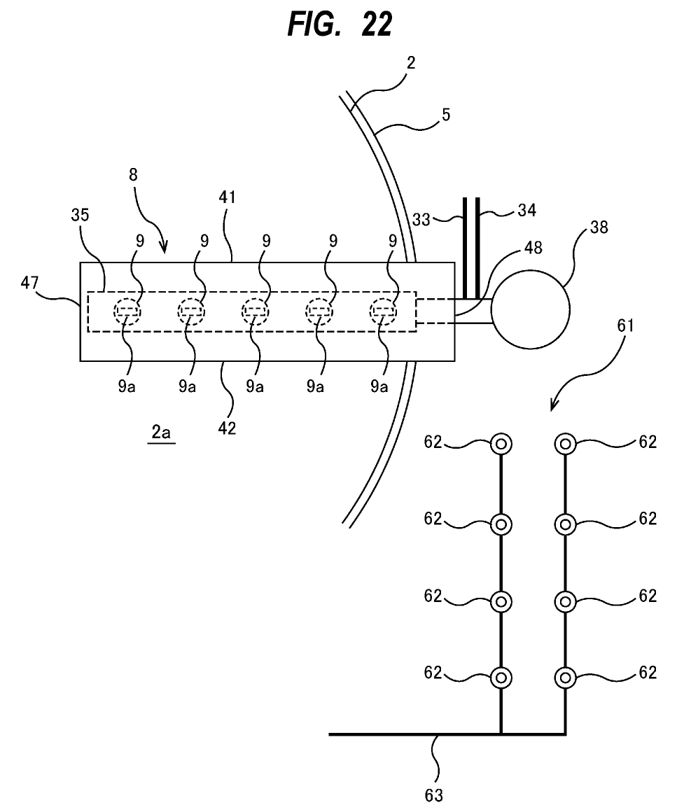

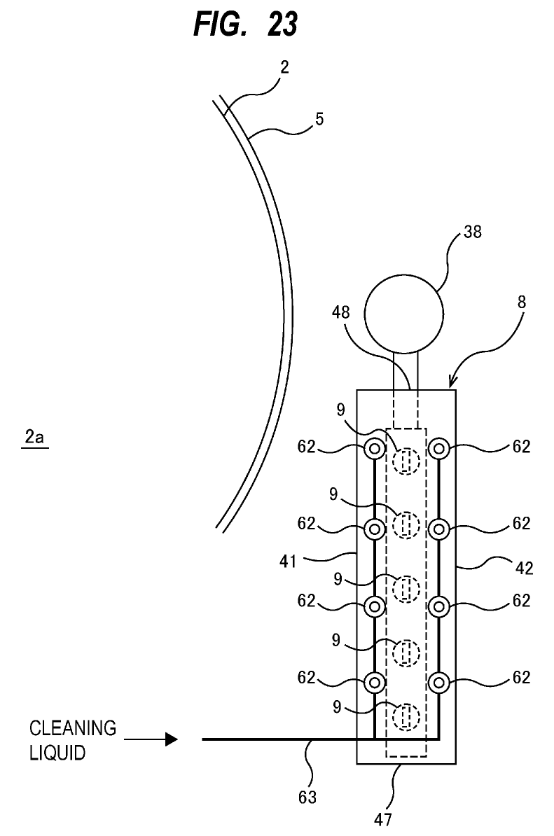

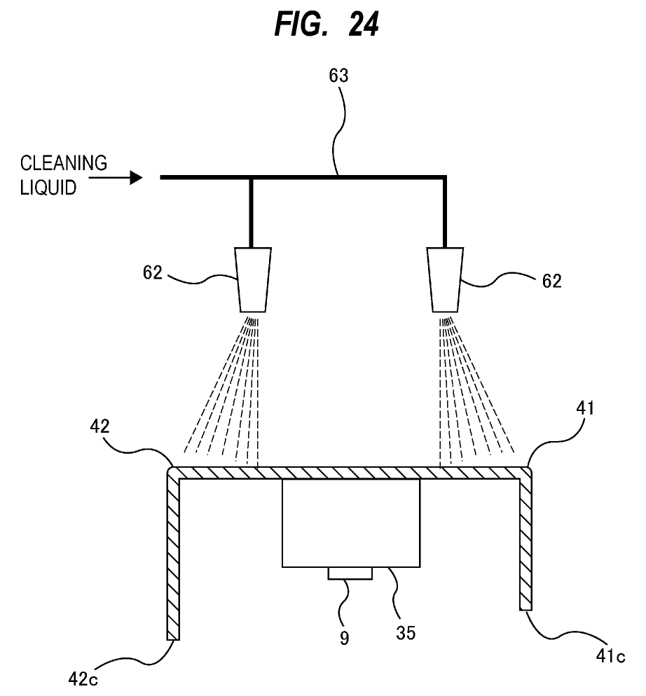

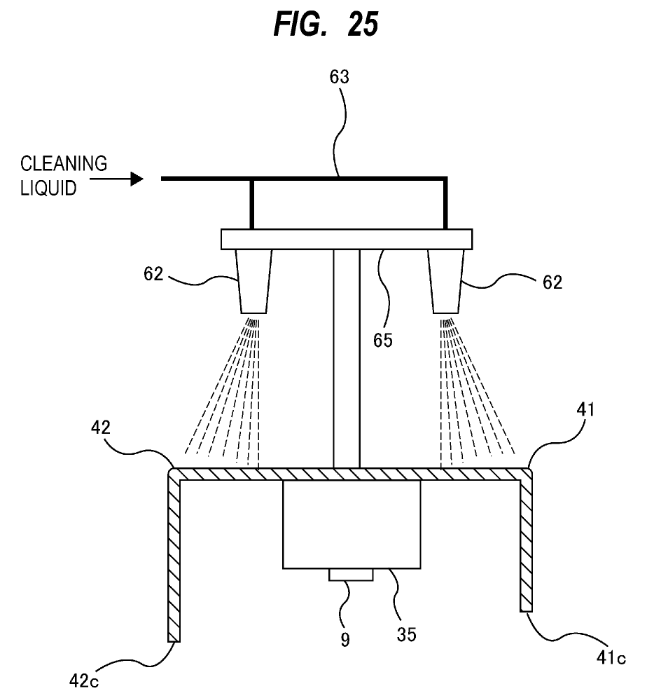

### BRIEF DESCRIPTION OF THE DRAWINGS

[FIG. 1] FIG. 1 is a schematic diagram showing an embodiment of a polishing apparatus including a non-contact pad cleaning apparatus.

[FIG. 2] FIG. 2 is a top view showing an embodiment of the non-contact pad cleaning apparatus.

[FIG. 3] FIG. 3 is a view of a polishing-surface cleaning device as seen from below.

[FIG. 4] FIG. 4 is a cross-sectional view taken along line A-A of FIG. 2.

[FIG. 5] FIG. 5 is a diagram showing a comparative example in which a distance from a polishing surface of a polishing pad to a lower end of an upstream-side nozzle cover is the same as a distance from the polishing surface to a lower end of a downstream-side nozzle cover.

[FIG. 6] FIG. 6 is a diagram showing an embodiment in which the distance from the polishing surface of the polishing pad to the lower end of the upstream-side nozzle cover is larger than the distance from the polishing surface to the lower end of the downstream-side nozzle cover.

[FIG. 7] FIG. 7 is a diagram showing an embodiment in which the upstream-side nozzle cover and the downstream-side nozzle cover are fixed to both side surfaces of the nozzle carrier.

[FIG. 8] FIG. 8 is a diagram for explaining a velocity vector of a part of liquid spread on the polishing surface after the two-fluid jet collides with the polishing surface, and a velocity vector of the liquid on the polishing surface of the rotating polishing pad.

[FIG. 9] FIG. 9 is a top view for explaining an embodiment in which the polishing-surface cleaning device including a plurality of two-fluid nozzles is oscillated above the polishing surface of the polishing pad.

[FIG. 10] FIG. 10 is a diagram showing an embodiment of an arrangement of a plurality of ejection ports of the plurality of two-fluid nozzles.

[FIG. 11] FIG. 11 is a diagram showing another embodiment of the plurality of ejection ports of the plurality of two-fluid nozzles.

[FIG. 12] FIG. 12 is a diagram showing still another embodiment of the plurality of ejection ports of the plurality of two-fluid nozzles.

[FIG. 13] FIG. 13 is a diagram showing still another embodiment of the plurality of ejection ports of the plurality of two-fluid nozzles.

[FIG. 14] FIG. 14 is a top view showing another embodiment of the upstream-side nozzle cover and the downstream-side nozzle cover.

[FIG. 15] FIG. 15 is a cross-sectional view taken along line B-B of FIG. 14.

[FIG. 16] FIG. 16 is a cross-sectional view showing still another embodiment of the upstream-side nozzle cover and the downstream-side nozzle cover.

[FIG. 17] FIG. 17 is a cross-sectional view showing still another embodiment of the upstream-side nozzle cover and the downstream-side nozzle cover.

[FIG. 18] FIG. 18 is a cross-sectional view showing still another embodiment of the upstream-side nozzle cover and the downstream-side nozzle cover.

[FIG. 19] FIG. 19 is a top view showing still another embodiment of the non-contact pad cleaning apparatus.

[FIG. 20] FIG. 20 is a top view for explaining an operation of moving the polishing-surface cleaning device from a position above the polishing surface to a position above a plurality of cleaning nozzles.

[FIG. 21] FIG. 21 is a diagram showing the plurality of cleaning nozzles when emitting a cleaning liquid onto inner surfaces of the upstream-side nozzle cover and the downstream-side nozzle cover.

[FIG. 22] FIG. 22 is a top view showing still another embodiment of the non-contact pad cleaning apparatus.

[FIG. 23] FIG. 23 is a top view for explaining an operation of moving the polishing-surface cleaning device from a position above the polishing surface to a position below a plurality of cleaning nozzles.

[FIG. 24] FIG. 24 is a diagram showing the plurality of cleaning nozzles when emitting a cleaning liquid onto outer surfaces of the upstream-side nozzle cover and the downstream-side nozzle cover.

[FIG. 25] FIG. 25 is a top view showing still another embodiment of the non-contact pad cleaning apparatus.

### DESCRIPTION OF EMBODIMENTS

Hereinafter, embodiments will be described with reference to the drawings. FIG. 1 is a schematic diagram showing an embodiment of a polishing apparatus including a non-contact pad cleaning apparatus. The polishing apparatus is an device for chemically mechanically polishing a wafer W which is an example of a workpiece used for manufacturing of semiconductor devices. As shown in FIG. 1, this polishing apparatus includes a rotary table 5 supporting a polishing pad 2 having a polishing surface 2a, a polishing head 7 configured to press the wafer W against the polishing surface 2a, a slurry supply nozzle 10 configured to supply slurry onto the polishing surface 2a, and a polishing-surface cleaning device 8 configured to clean the polishing surface 2a of the polishing pad 2. The polishing-surface cleaning device 8 is arranged above the polishing surface 2a of the polishing pad 2 and faces the polishing surface 2a.

The polishing head 7 is configured to be able to hold the wafer W on its lower surface. The wafer W has a film to be polished. In the following embodiments, a wafer is used as an example of the workpiece, but the workpiece is not limited to the wafer, and may be a circular substrate, a rectangular substrate, an interconnect board, a panel, or the like for use in manufacturing of semiconductor devices.

The polishing apparatus further includes a support shaft 14, a polishing-head swing arm 16 coupled to an upper end of the support shaft 14, and a polishing-head shaft 18 rotatably supported by a free end of the polishing-head swing arm 16. The polishing head 7 is fixed to a lower end of the polishing-head shaft 18. A polishing-head rotating mechanism (not shown) including an electric motor is arranged in the polishing-head swing arm 16. This polishing-head rotating mechanism is coupled to the polishing-head shaft 18, and is configured to rotate the polishing-head shaft 18 and the polishing head 7 in a direction indicated by an arrow.

The polishing-head shaft 18 is coupled to a polishing-head elevating mechanism (including a ball screw mechanism, etc.) not shown. This polishing-head elevating mechanism is configured to move the polishing-head shaft 18 up and down relative to the polishing-head swing arm 16. This vertical movement of the polishing-head shaft 18 can cause the polishing head 7 to move up and down relative to the polishing-head swing arm 16 and the rotary table 5 as indicated by an arrow.

The polishing apparatus further includes a table rotation motor 21 configured to rotate the polishing pad 2 and the rotary table 5 about their axes. The table rotation motor 21 is arranged below the rotary table 5, and the rotary table 5 is coupled to the table rotation motor 21 via a table shaft 5a. The rotary table 5 and the polishing pad 2 are rotated by the table rotation motor 21 about the table shaft 5a in a direction indicated by an arrow. The polishing pad 2 is attached to an upper surface of the rotary table 5. An exposed surface of the polishing pad 2 constitutes the polishing surface 2a for polishing the wafer W.

Polishing of the wafer W is performed as follows. The wafer W is held by the polishing head 7 with a surface of the wafer W to be polished facing downward. While the polishing head 7 and the rotary table 5 are rotated individually, the slurry is supplied onto the polishing surface 2a of the polishing pad 2 from the slurry supply nozzle 10 provided above the rotary table 5. The polishing pad 2 is rotated together with the rotary table 5 about a central axis of the polishing pad 2. The polishing head 7 is moved to a predetermined height by the polishing-head elevating mechanism (not shown). Furthermore, the polishing head 7 presses the wafer W against the polishing surface 2a of the polishing pad 2 while the polishing head 7 is maintained at the predetermined height. The wafer W is rotated by the polishing head 7. With the slurry present on the polishing surface 2a of the polishing pad 2, the wafer W is brought into sliding contact with the polishing surface 2a. The surface of the wafer W is polished by a combination of a chemical action of the slurry and a mechanical action of abrasive grains contained in the slurry and/or the polishing pad 2.

The polishing apparatus includes a dresser 22 configured to dress the polishing surface 2a of the polishing pad 2. This dresser 22 includes a dressing disk 23 to be brought into sliding contact with the polishing surface 2a of the polishing pad 2, a dresser shaft 24 to which the dressing disk 23 is coupled, and a dresser swing arm 25 rotatably supporting the dresser shaft 24. A lower surface of the dressing disk 23 constitutes a dressing surface 23a, and this dressing surface 23a is composed of abrasive grains (e.g., diamond particles).

The dresser shaft 24 is coupled to a disk pressing mechanism (including, e.g., an air cylinder), which is not shown, arranged in the dresser swing arm 25. This disk pressing mechanism is configured to press the dressing surface 23a of the dressing disk 23 against the polishing surface 2a of the polishing pad 2 via the dresser shaft 24. Further, the dresser shaft 24 is coupled to a disk rotating mechanism (including, e.g., an electric motor), which is not shown, arranged in the dresser swing arm 25. This disk rotating mechanism is configured to rotate the dressing disk 23 in a direction indicated by an arrow via the dresser shaft 24.

Dressing of the polishing surface 2a of the polishing pad 2 is performed as follows. The polishing pad 2 is rotated by the table rotation motor 21 together with the rotary table 5. While the dressing disk 23 is rotated about the dresser shaft 24 by the disk rotating mechanism (not shown), the dressing surface 23a of the dressing disk 23 is pressed against the polishing surface 2a by the disk pressing mechanism (not shown), so that the dressing surface 23a of the dressing disk 23 is brought into sliding contact with the polishing surface 2a. During rotation of the dressing disk 23, the dresser swing arm 25 is pivoted about a support shaft 28 to oscillate the dressing disk 23 in a radial direction of the polishing surface 2a. In this manner, the polishing pad 2 is slightly scraped off by the dressing disk 23, so that the polishing surface 2a is dressed (regenerated). The dressing of the polishing surface 2a of the polishing pad 2 is performed during the polishing of the wafer W or after the polishing of the wafer W.

The polishing apparatus includes an operation controller 30 configured to control operations of the polishing apparatus including the polishing operation and the dressing operation for the wafer W. The operation controller 30 is composed of at least one computer. The operation controller 30 includes a memory 30a storing a program, and a processor 30b configured to execute an arithmetic operation according to instructions included in the program. The memory 30a includes a main memory, such as a random access memory (RAM), and an auxiliary memory, such as a hard disk drive (HDD) or a solid state drive (SSD). Examples of the processor 30b include a CPU (Central Processing Unit) and a GPU (Graphic Processing Unit). However, a specific configuration of the operation controller 30 is not limited to these examples.

Next, the non-contact pad cleaning apparatus for cleaning the polishing surface 2a of the polishing pad 2 will be described. FIG. 2 is a top view showing an embodiment of the non-contact pad cleaning apparatus, FIG. 3 is a view of the polishing-surface cleaning device 8 as seen from below, and FIG. 4 is a cross-sectional view taken along line A-A of FIG. 2. The non-contact pad cleaning apparatus for cleaning the polishing surface 2a of the polishing pad 2 in a non-contact manner includes the polishing-surface cleaning device 8 having a plurality of two-fluid nozzles 9 configured to emit two fluids toward the polishing surface 2a of the polishing pad 2, and a liquid supply line 33 and a gas supply line 34 coupled to the plurality of two-fluid nozzles 9.

In the embodiment shown in FIG. 2, the non-contact pad cleaning apparatus further includes the rotary table 5 and the operation controller 30 shown in FIG. 1. The rotary table 5 and the operation controller 30 constitute a part of the non-contact pad cleaning apparatus, while the rotary table 5 and the operation controller 30 constitute a part of the polishing apparatus shown in FIG. 1 as well.

The plurality of two-fluid nozzles 9 are arranged at different distances from a center CP of the polishing pad 2. In the embodiment shown in FIG. 2, the plurality of two-fluid nozzles 9 are arranged in the radial direction of the polishing pad 2. Specifically, when viewed from above the polishing pad 2, the plurality of two-fluid nozzles 9 are arranged on a straight line RL passing through the center CP of the polishing pad 2 and extending in the radial direction of the polishing pad 2. The straight line RL is an imaginary line. The plurality of two-fluid nozzles 9 are located above the polishing surface 2a of the polishing pad 2. An outermost two-fluid nozzle 9 among the plurality of two-fluid nozzles 9 is located radially inward of the peripheral edge of the polishing pad 2.

The plurality of two-fluid nozzles 9 have a plurality of ejection ports 9a, respectively, for emitting the two fluids. The polishing-surface cleaning device 8 further includes a nozzle carrier 35 holding the plurality of two-fluid nozzles 9, and an upstream-side nozzle cover 41 and a downstream-side nozzle cover 42 fixed to the nozzle carrier 35. The plurality of ejection ports 9a are arranged at different distances from the center CP of the polishing pad 2. The nozzle carrier 35 is held by a holding arm 44, and the holding arm 44 is coupled to a nozzle oscillation mechanism 38. The liquid supply line 33 and the gas supply line 34 extend in the holding arm 44 and the nozzle carrier 35 and communicate with the plurality of two-fluid nozzles 9.

A liquid and a gas are supplied to the plurality of two-fluid nozzles 9 through the liquid supply line 33 and the gas supply line 34, and are mixed in each two-fluid nozzle 9 to form a two-fluid jet which is a fluid mixture of the liquid and the gas. The two-fluid jet is emitted from the plurality of ejection ports 9a of the plurality of two-fluid nozzles 9 onto the polishing surface 2a of the polishing pad 2. Examples of the liquid supplied from the liquid supply line 33 to the plurality of two-fluid nozzles 9 include pure water and pure water containing fine bubbles. Examples of the gas supplied from the gas supply line 34 to the plurality of two-fluid nozzles 9 include air and inert gas (e.g., nitrogen gas). The liquid supply line 33 and the gas supply line 34 are coupled to a liquid supply source (not shown) and a gas supply source (not shown), respectively.

The ejection port 9a of each two-fluid nozzle 9 has a slit shape and is configured to form a fan-shaped two-fluid jet. As shown in FIG. 3, in the present embodiment, each of the plurality of ejection ports 9a is parallel to a longitudinal direction of the nozzle carrier 35. More specifically, each ejection port 9a is parallel to the straight line RL passing through the center CP of the polishing pad 2 and extending in the radial direction of the polishing pad 2. The plurality of ejection ports 9a are arranged along the longitudinal direction of the nozzle carrier 35, and are configured to clean the polishing surface 2a by emitting the two-fluid jet onto the polishing surface 2a of the polishing pad 2.

The two-fluid jet, which is the fluid mixture of the liquid and the gas, gives a stronger impact to the polishing surface 2a of the polishing pad 2 than a jet flow of liquid. Therefore, the polishing debris and the abrasive grains of the slurry can be removed from a large number of holes formed in the polishing surface 2a of the polishing pad 2. On the other hand, the liquid contained in the two fluids is likely to scatter when the two-fluid jet impinges on the polishing surface 2a. Since the liquid contains the polishing debris and the slurry, if the scattered liquid comes into contact with the polishing surface 2a of the polishing pad 2 again, the scattered liquid may adversely affect the polishing of the wafer.

Therefore, in the present embodiment, the polishing-surface cleaning device 8 includes the upstream-side nozzle cover 41 and the downstream-side nozzle cover 42 for preventing scattering of the liquid. The upstream-side nozzle cover 41 and the downstream-side nozzle cover 42 are fixed to the nozzle carrier 35. The upstream-side nozzle cover 41 and the downstream-side nozzle cover 42 are arranged at both sides of the plurality of two-fluid nozzles 9. Specifically, the upstream-side nozzle cover 41 is arranged upstream of the plurality of two-fluid nozzles 9 in the rotation direction of the polishing pad 2, and the downstream-side nozzle cover 42 is arranged downstream of the plurality of two-fluid nozzles 9 in the rotation direction of the polishing pad 2. The upstream-side nozzle cover 41 and the downstream-side nozzle cover 42 extend along an arrangement direction of the plurality of two-fluid nozzles 9.

An inner end portion 41a of the upstream-side nozzle cover 41 is located between the center CP of the polishing pad 2 and an innermost two-fluid nozzle 9 among the plurality of two-fluid nozzles 9. An outer end portion 41b of the upstream-side nozzle cover 41 is located radially outward of the peripheral edge of the polishing pad 2. The polishing-surface cleaning device 8 of the present embodiment further includes an inner cover 47 coupled to the inner end portion 41a of the upstream-side nozzle cover 41 and an inner end portion 42a of the downstream-side nozzle cover 42. The inner cover 47 is located radially inward of the plurality of two-fluid nozzles 9.

Since a velocity of an outer peripheral portion of the polishing pad 2 in a circumferential direction is high, a large amount of liquid tends to scatter when the two-fluid jet collides with the outer peripheral portion of the polishing pad 2. Furthermore, the liquid on the polishing surface 2a scatters from the peripheral edge of the polishing pad 2 by a centrifugal force. In order to catch these scattered liquids, the polishing-surface cleaning device 8 of the present embodiment includes an outer cover 48 coupled to the outer end portion 41b of the upstream-side nozzle cover 41 and an outer end portion 42b of the downstream-side nozzle cover 42. The outer cover 48 is located radially outward of the plurality of two-fluid nozzles 9 and located radially outward of the peripheral edge of the polishing pad 2. In one embodiment, the outer end portion 41b of the upstream-side nozzle cover 41, the outer end portion 42b of the downstream-side nozzle cover 42, and the outer cover 48 are located away from the peripheral edge of the polishing pad 2 by 15 mm or more in the radial direction of the polishing pad 2.

In one embodiment, the upstream-side nozzle cover 41, the downstream-side nozzle cover 42, the inner cover 47, and the outer cover 48 form an integral structure. The upstream-side nozzle cover 41, the downstream-side nozzle cover 42, the inner cover 47, and the outer cover 48 are coupled without a gap. The upstream-side nozzle cover 41, the downstream-side nozzle cover 42, the inner cover 47, and the outer cover 48 form a rectangular cover structure as a whole, and surround the entireties of the plurality of two-fluid nozzles 9 and the nozzle carrier 35. Therefore, the upstream-side nozzle cover 41, the downstream-side nozzle cover 42, the inner cover 47, and the outer cover 48 can prevent scattering of the liquid when the two-fluid jet impinges upon the polishing surface 2a of the polishing pad 2.

Since the outer end portion 41b of the upstream-side nozzle cover 41, the outer end portion 42b of the downstream-side nozzle cover 42, and the outer cover 48 are located radially outward of the peripheral edge of the polishing pad 2, a part of the liquid that has come into contact with inner surfaces of the upstream-side nozzle cover 41 and the downstream-side nozzle cover 42 flows radially outward along the upstream-side nozzle cover 41 and the downstream-side nozzle cover 42, and is discharged from the polishing surface 2a.

As shown in FIG. 4, a distance D1 from the polishing surface 2a of the polishing pad 2 to a lower end 41c of the upstream-side nozzle cover 41 is larger than a distance D2 from the polishing surface 2a to a lower end 42c of the downstream-side nozzle cover 42. In one embodiment, the distance D1 is in a range of 10 mm to 20 mm, and the distance D2 is in a range of 3 mm to 9 mm. The reason why the distance D1 is larger than the distance D2 will be described with reference to FIGS. 5 and 6.

FIG. 5 is a diagram showing a comparative example in which the distance from the polishing surface 2a of the polishing pad 2 to the lower end 41c of the upstream-side nozzle cover 41 is the same as the distance from the polishing surface 2a to the lower end 42c of the downstream-side nozzle cover 42. As shown in FIG. 5, the two-fluid jet emitted from the two-fluid nozzle 9 collides with the polishing surface 2a of the polishing pad 2, and thereafter, the liquid in the two fluids flows to the upstream side and the downstream side on the polishing surface 2a. The liquid flowing to the downstream side passes through a gap between the lower end 42c of the downstream-side nozzle cover 42 and the polishing surface 2a. The liquid flowing to the upstream side also passes through a gap between the lower end 41c of the upstream-side nozzle cover 41 and the polishing surface 2a, but a part of the liquid is dragged by the polishing surface 2a of the rotating polishing pad 2 to flow backward, and is dammed by the two-fluid jet emitted from the two-fluid nozzle 9. As a result, a liquid film is formed between the two-fluid jet and the lower end 41c of the upstream-side nozzle cover 41.

If the distance from the polishing surface 2a of the polishing pad 2 to the lower end 41c of the upstream-side nozzle cover 41 is small, the liquid film comes into contact with the lower end 41c of the upstream-side nozzle cover 41 as shown in FIG. 5, thus closing the gap between the polishing surface 2a and the lower end 41c of the upstream-side nozzle cover 41. As a result, the liquid flowing to the upstream side may not pass through the gap between the polishing surface 2a and the lower end 41c of the upstream-side nozzle cover 41, and as a result, an amount (or a thickness) of the liquid film between the two-fluid nozzle 9 and the upstream-side cover 41 increases. A part of the two-fluid jet emitted from the two-fluid nozzle 9 is inhibited by the liquid film and cannot impinge on the polishing surface 2a of the polishing pad 2. As a result, a desired cleaning result of the polishing surface 2a cannot be achieved.

FIG. 6 is a diagram showing an embodiment in which the distance from the polishing surface 2a of the polishing pad 2 to the lower end 41c of the upstream-side nozzle cover 41 is larger than the distance from the polishing surface 2a to the lower end 42c of the downstream-side nozzle cover 42. As shown in FIG. 6, since the distance between the lower end 41c of the upstream-side nozzle cover 41 and the polishing surface 2a is large, the liquid film is unlikely to come into contact with the lower end 41c of the upstream-side nozzle cover 41. Particularly, when the distance between the lower end 41c of the upstream-side nozzle cover 41 and the polishing surface 2a is in the range of 10 mm to 20 mm, the liquid film is unlikely to come into contact with the lower end 41c of the upstream-side nozzle cover 41.

Therefore, the liquid flowing to the upstream side can pass through the gap between the lower end 41c of the upstream-side nozzle cover 41 and the polishing surface 2a. A part of the liquid film is carried by the liquid flowing to the upstream side and flows out from the gap between the lower end 41c of the upstream-side nozzle cover 41 and the polishing surface 2a. Another part of the liquid film flows radially outward of the polishing pad 2 and is discharged from the polishing surface 2a. Therefore, the thickness of the liquid film does not become large. As a result, the two-fluid jet emitted from the two-fluid nozzle 9 impinges on the polishing surface 2a of the polishing pad 2 without being inhibited by the liquid film, and can therefore clean the polishing surface 2a.

On the other hand, from a viewpoint of preventing passage of droplets that scatter when the two-fluid jet from the two-fluid nozzle 9 collides with the polishing surface 2a, it is preferable that the distance D2 from the polishing surface 2a to the lower end 42c of the downstream-side nozzle cover 42 is small. Therefore, in one embodiment, the distance D2 is in the range of 3 mm to 9 mm.

In the embodiment shown in FIG. 4, the upstream-side nozzle cover 41 and the downstream-side nozzle cover 42 are fixed to an upper surface 35a of the nozzle carrier 35, and the upstream-side nozzle cover 41 and the downstream-side nozzle cover 42 are coupled to each other at the upper surface 35a of the nozzle carrier 35 to form an integral structure.

In one embodiment, as shown in FIG. 7, the upstream-side nozzle cover 41 and the downstream-side nozzle cover 42 may be fixed to both side surfaces 35b, 35c of the nozzle carrier 35, respectively. The embodiment shown in FIG. 7 can reduce areas of the inner surfaces of the upstream-side nozzle cover 41 and the downstream-side nozzle cover 42. The droplets bounced off from the polishing surface 2a of the polishing pad 2 contain the polishing debris and the slurry. The droplets containing the polishing debris and the slurry adhere to the inner surfaces of the upstream-side nozzle cover 41 and the downstream-side nozzle cover 42. According to this embodiment, since the areas of the inner surfaces of the upstream-side nozzle cover 41 and the downstream-side nozzle cover 42 are small, an amount of droplets adhering to the inner surfaces of the upstream-side nozzle cover 41 and the downstream-side nozzle cover 42 decreases. Furthermore, it is easy to clean the inner surfaces of the upstream-side nozzle cover 41 and the downstream-side nozzle cover 42.

FIG. 8 is a diagram for explaining a velocity vector of a part of liquid spread on the polishing surface 2a after the two-fluid jet collides with the polishing surface 2a, and a velocity vector of the liquid on the polishing surface 2a of the rotating polishing pad 2. When the two-fluid jet emitted from the two-fluid nozzle 9 collides with the polishing surface 2a, the liquid in the two fluids spreads on the polishing surface 2a. White arrows shown in FIG. 8 represent a velocity vector V1 of a part of the liquid spread on the polishing surface 2a after the two-fluid jet collides with the polishing surface 2a. Black arrows shown in FIG. 8 represent a velocity vector V2 of the liquid dragged by the polishing surface 2a of the rotating polishing pad 2. The velocity vector V1 and the velocity vector V2 are perpendicular to the radial direction of the polishing pad 2. The velocity vector V1 and the velocity vector V2 are opposite to each other.

A dotted ellipse T shown in FIG. 8 represents a liquid landing region where the two-fluid jet emitted from the ejection port 9a of the two-fluid nozzle 9 collides with the polishing surface 2a. Since the two-fluid jet emitted from the two-fluid nozzle 9 is fan-shaped, the liquid landing region T on the polishing surface 2a has an elliptical shape. The larger the velocity vector V1 and the velocity vector V2 are, the more easily the liquid scatters. As shown in FIG. 8, the velocity vector V2 increases according to the distance from the center CP of the polishing pad 2. Therefore, the liquid is more likely to scatter at the outer peripheral portion of the polishing pad 2. Since the upstream-side nozzle cover 41 and the downstream-side nozzle cover 42 are arranged at the upstream side and the downstream side of all the two-fluid nozzles 9 including the outermost two-fluid nozzle 9, the upstream-side nozzle cover 41 and the downstream-side nozzle cover 42 can prevent scattering of the liquid.

A magnitude of the velocity vector V1 is minimized when the ejection port 9a of each two-fluid nozzle 9 is parallel to the radial direction of the polishing pad 2 (parallel to the straight line RL). Therefore, from a viewpoint of reducing scattering of the liquid, the arrangement of the ejection ports 9a of the two-fluid nozzles 9 shown in FIG. 8 may be desirable. On the other hand, as shown in FIG. 8, there is a gap between the adjacent liquid landing regions T. This indicates that there is a region where the two-fluid jet does not collide. In the region where the two-fluid jet does not collide, the polishing debris and the slurry may not be removed.

Therefore, in order to eliminate the region where the two-fluid jet does not collide, in one embodiment, as shown in FIG. 9, the operation controller 30 instructs the nozzle oscillation mechanism 38 to oscillate the polishing-surface cleaning device 8 including the plurality of two-fluid nozzles 9, the upstream-side nozzle cover 41, the downstream-side nozzle cover 42, the inner cover 47, and the outer cover 48 at an oscillation angle θ above the polishing surface 2a of the polishing pad 2. Since the plurality of two-fluid nozzles 9 emit the two-fluid jet onto the polishing surface 2a while moving over the polishing surface 2a, the plurality of two-fluid nozzles 9 can dispense the two-fluid jet to the entire polishing surface 2a.

The oscillation angle θ is set by the operation controller 30 and is changeable. In one embodiment, the oscillation angle θ is changeable within a range of 0 to 45 degrees. When the oscillation angle θ is small, a large amount of the two fluids can be supplied to a central region of the polishing surface 2a of the polishing pad 2, so that a wet state of the polishing surface 2a can be easily maintained. On the other hand, when the oscillation angle θ is large, the two-fluid jet emitted from the plurality of two-fluid nozzles 9 pushes out the polishing debris, the slurry, and the liquid contained in the two fluids themselves to the outside of the polishing pad 2, making it easier to discharge them from the polishing pad 2. In addition, the liquid film described with reference to FIG. 6 becomes thinner, so that the two-fluid jet can collide with the polishing surface 2a of the polishing pad 2. As a result, the cleaning effect of the polishing pad 2 is improved.

In one embodiment, as shown in FIG. 10, the plurality of two-fluid nozzles 9 may not be arranged in the radial direction of the polishing pad 2. In the example shown in FIG. 10, when viewed from above the polishing pad 2, the plurality of ejection ports 9a of the plurality of two-fluid nozzles 9 are arranged parallel to the straight line RL extending in the radial direction of the polishing pad 2, but are not on the straight line RL. With this arrangement, the velocity vector V1 of the liquid when the two-fluid jet collides with the polishing surface 2a is slightly larger than that in the embodiment shown in FIG. 8, while at the outer peripheral portion of the polishing pad 2 where scattering of the liquid is likely to occur, the velocity vector V1 has approximately the same magnitude as that in the embodiment shown in FIG. 8. Furthermore, although not shown in FIG. 10, since the upstream-side nozzle cover 41 and the downstream-side nozzle cover 42 are arranged on the upstream side and the downstream side of all the two-fluid nozzles 9 including the outermost two-fluid nozzle 9, the upstream-side nozzle cover 41 and the downstream-side nozzle cover 42 can prevent scattering of the liquid.

Also in this embodiment shown in FIG. 10, as described with reference to FIG. 9, the operation controller 30 may instruct the nozzle oscillation mechanism 38 to oscillate the polishing-surface cleaning device 8 including the plurality of two-fluid nozzles 9 above the polishing surface 2a of the polishing pad 2 at a preset oscillation angle.

FIG. 11 is a diagram showing another embodiment of the plurality of ejection ports 9a of the plurality of two-fluid nozzles 9. In the embodiment shown in FIG. 11, the plurality of ejection ports 9a of the plurality of two-fluid nozzles 9 are inclined with respect to the radial direction of the polishing pad 2. Specifically, each ejection port 9a is inclined with respect to the straight line RL passing through the center CP of the polishing pad 2. In one embodiment, each ejection port 9a is inclined within a range of 5 to 15 degrees with respect to the straight line RL passing through the center CP of the polishing pad 2. The liquid landing regions T where the two-fluid jet emitted from the plurality of ejection ports 9a collides with the polishing surface 2a of the polishing pad 2 are also inclined with respect to the radial direction of the polishing pad 2 (i.e., the straight line RL).

The plurality of liquid landing regions T are separated from each other, and there is a gap between adjacent liquid landing regions T. The liquid dragged by the polishing surface 2a of the rotating polishing pad 2 can pass through the gap between the liquid landing regions T. Therefore, the liquid film is unlikely to be formed on the upstream side of the plurality of two-fluid nozzles 9. Furthermore, the plurality of liquid landing regions T overlap in a direction perpendicular to the radial direction of the polishing pad 2 (direction perpendicular to the straight line RL). Therefore, when the polishing pad 2 is rotating, the two-fluid jet can clean the entire target cleaning area in the polishing surface 2a without oscillating the plurality of two-fluid nozzles 9. In the embodiment shown in FIG. 11, the nozzle oscillation mechanism 38 shown in FIG. 2 may not be provided.

On the other hand, the velocity vector V1 of the liquid when the two-fluid jet collides with the polishing surface 2a is slightly larger than that in the embodiment shown in FIG. 8. This is because each liquid landing region T is inclined with respect to the radial direction of the polishing pad 2, and a velocity component in the direction perpendicular to the radial direction is large. However, since the upstream-side nozzle cover 41 and the downstream-side nozzle cover 42 are arranged at the upstream side and the downstream side of all the two-fluid nozzles 9, the upstream-side nozzle cover 41 and the downstream-side nozzle cover 42 can prevent scattering of the liquid.

FIG. 12 is a diagram showing still another embodiment of the plurality of ejection ports 9a of the plurality of two-fluid nozzles 9. In the embodiment shown in FIG. 12, the plurality of ejection ports 9a are inclined at different angles with respect to the longitudinal direction of the nozzle carrier 35. These ejection ports 9a are arranged along a circular arc. Further, the plurality of ejection ports 9a are located on a plurality of straight lines RL, respectively, passing through the center CP of the polishing pad 2 and extending in a plurality of radial directions of the polishing pad 2 when viewed from above the polishing pad 2. Each ejection port 9a is parallel to the corresponding straight line RL. Specifically, the plurality of ejection ports 9a are parallel to the plurality of radial directions of the polishing pad 2.

According to such an arrangement, the velocity vector V1 of the liquid when the two-fluid jet collides with the polishing surface 2a has the same magnitude as that in the embodiment shown in FIG. 8, and scattering of the liquid can be suppressed. The plurality of liquid landing regions T overlap in the direction perpendicular to the radial direction of the polishing pad 2 (direction perpendicular to the straight line RL). Therefore, when the polishing pad 2 is rotating, the two-fluid jet can clean the entire target cleaning area in the polishing surface 2a without oscillating the plurality of two-fluid nozzles 9.

FIG. 13 is a diagram showing still another embodiment of the plurality of ejection ports 9a of the plurality of two-fluid nozzles 9. The embodiment shown in FIG. 13 is the same as the embodiment described with reference to FIG. 12 in that the plurality of ejection ports 9a are inclined at different angles with respect to the longitudinal direction of the nozzle carrier 35 and are located on the plurality of straight lines RL, respectively, extending in the radial directions of the polishing pad 2, but differs in that the plurality of ejection ports 9a are arranged linearly along the longitudinal direction of the nozzle carrier 35.

Also in this embodiment, the velocity vector V1 of the liquid when the two-fluid jet collides with the polishing surface 2a has the same magnitude as that in the embodiment shown in FIG. 8, and scattering of the liquid can be suppressed. Furthermore, since the plurality of liquid landing regions T overlap in the direction perpendicular to the radial direction of the polishing pad 2 (direction perpendicular to the straight line RL), the two-fluid jet can clean the entire target cleaning area in the polishing surface 2a without oscillating the plurality of two-fluid nozzles 9.

FIG. 14 is a top view showing another embodiment of the upstream-side nozzle cover 41 and the downstream-side nozzle cover 42, and FIG. 15 is a cross-sectional view taken along line B-B of FIG. 14. Configurations of this embodiment which are not particularly described are the same as those of the embodiment described with reference to FIGS. 1 to 4, and therefore redundant description thereof will be omitted. In this embodiment, a width W1 of the upstream-side nozzle cover 41 in a direction perpendicular to the longitudinal direction of the nozzle carrier 35 is larger than a width W2 of the downstream-side nozzle cover 42 in the direction perpendicular to the longitudinal direction of the nozzle carrier 35. The width W1 of the upstream-side nozzle cover 41 is a distance from the upstream side surface 35b of the nozzle carrier 35 to the upstream-side nozzle cover 41, and the width W2 of the downstream-side nozzle cover 42 is a distance from the downstream side surface 35c of the nozzle carrier 35 to the downstream-side nozzle cover 42.

According to this embodiment, since the width W1 of the upstream-side nozzle cover 41 is large, when the two-fluid jet emitted from the two-fluid nozzle 9 collides with the polishing surface 2a, droplets bounced off from the polishing surface 2a are unlikely to pass through the gap between the lower end 41c of the upstream-side nozzle cover 41 and the polishing surface 2a. Specifically, the upstream-side nozzle cover 41 can catch most of the droplets bounced off from the polishing surface 2a.

FIG. 16 is a cross-sectional view showing still another embodiment of the upstream-side nozzle cover 41 and the downstream-side nozzle cover 42. Configurations of this embodiment which are not particularly described are the same as those of the embodiment described with reference to FIGS. 1 to 4, and therefore redundant description thereof will be omitted. In this embodiment, the upstream-side nozzle cover 41 is inclined downward toward the upstream side in the rotation direction of the rotary table 5, and the downstream-side nozzle cover 42 is inclined downward toward the downstream side in the rotation direction of the rotary table 5.

When the two-fluid jet emitted from the two-fluid nozzle 9 collides with the polishing surface 2a of the polishing pad 2, the liquid bounces off from the polishing surface 2a, and the liquid is caught by the inner surfaces of the upstream-side nozzle cover 41 and the downstream-side nozzle cover 42. Since the upstream-side nozzle cover 41 and the downstream-side nozzle cover 42 are inclined downward toward their lower ends 41c, 42c, the liquid flows downward on the inclined inner surfaces and falls onto the polishing surface 2a. Therefore, this configuration makes it possible to prevent the polishing debris and the slurry contained in the liquid from remaining on the inner surfaces of the upstream-side nozzle cover 41 and the downstream-side nozzle cover 42. Furthermore, even if the liquid scatters onto outer surfaces of the upstream-side nozzle cover 41 and the downstream-side nozzle cover 42, the liquid flows downward on the inclined outer surfaces of the upstream-side nozzle cover 41 and the downstream-side nozzle cover 42 and falls onto the polishing surface 2a. Therefore, the configuration of this embodiment makes it possible to prevent the polishing debris and the slurry contained in the liquid from remaining on the outer surfaces of the upstream-side nozzle cover 41 and the downstream-side nozzle cover 42.

FIG. 17 and FIG. 18 are cross-sectional views showing still another embodiment of the upstream-side nozzle cover 41 and the downstream-side nozzle cover 42. Configurations of this embodiment which are not particularly described are the same as those of the embodiment described with reference to FIGS. 1 to 4, and therefore redundant description thereof will be omitted. In the embodiment shown in FIGS. 17 and 18, the upstream-side nozzle cover 41 and the downstream-side nozzle cover 42 have a wing shape.

In FIG. 17, the upstream-side nozzle cover 41 and the downstream-side nozzle cover 42 have the same shape. In FIG. 18, the width W1 of the upstream-side nozzle cover 41 in the direction perpendicular to the longitudinal direction of the nozzle carrier 35 is larger than the width W2 of the downstream-side nozzle cover 42 in the direction perpendicular to the longitudinal direction of the nozzle carrier 35.

In the embodiments of FIGS. 17 and 18, the width of the upstream-side nozzle cover 41 and the width of the downstream-side nozzle cover 42 increase according to the distance from the center CP of the polishing pad 2. As described with reference to FIG. 8, the larger the distance from the center CP of the polishing pad 2 is, the more easily the liquid scatters. The wing-shaped upstream-side nozzle cover 41 and downstream-side nozzle cover 42 shown in FIGS. 17 and 18 can effectively prevent scattering of the liquid.

Cleaning of the polishing surface 2a of the polishing pad 2 by the non-contact pad cleaning apparatus is performed after the wafer W is polished and before the next wafer is polished. Cleaning of the polishing surface 2a of the polishing pad 2 using the two-fluid nozzles 9 (which may be hereinafter referred to as pad cleaning operation) may be performed before or after dressing of the polishing surface 2a of the polishing pad 2 using the dresser 22 (which may be hereinafter referred to as dressing operation), or may be performed during the dressing operation.

For example, after polishing of the wafer W, the dressing operation may be performed, and then the pad cleaning operation may be performed. In another example, after polishing of the wafer W, the dressing operation and the pad cleaning operation may be performed simultaneously. In still another example, the dressing operation may be performed while the wafer W is polished, and the pad cleaning operation may be performed after the polishing of the wafer W and the dressing operation. Time of the pad cleaning operation, i.e., cleaning time of the polishing pad 2 using the two-fluid nozzles 9, can be arbitrarily set.

FIG. 19 is a top view showing still another embodiment of the non-contact pad cleaning apparatus. Configurations of this embodiment which are not particularly described are the same as those of the embodiment described with reference to FIGS. 1 to 4, and therefore redundant description thereof will be omitted. The non-contact pad cleaning apparatus further includes a cover-inner-surface cleaning device 51 configured to clean the inner surfaces of the upstream-side nozzle cover 41 and the downstream-side nozzle cover 42. The cover-inner-surface cleaning device 51 includes a plurality of cleaning nozzles 52 arranged radially outward of the rotary table 5, and a cleaning-liquid supply line 53 coupled to these cleaning nozzles 52. The cleaning-liquid supply line 53 is coupled to a cleaning-liquid supply source (not shown).

Cleaning of the upstream-side nozzle cover 41 and the downstream-side nozzle cover 42 is performed after cleaning of the polishing surface 2a of the polishing pad 2 performed by the non-contact pad cleaning apparatus is finished. Specifically, as shown in FIG. 20, the nozzle oscillation mechanism 38 moves the polishing-surface cleaning device 8 from a position above the polishing surface 2a to a position above the plurality of cleaning nozzles 52. The plurality of cleaning nozzles 52 are located lower than the upstream-side nozzle cover 41 and the downstream-side nozzle cover 42. A cleaning liquid (e.g., pure water, or a chemical liquid, or a combination thereof) is supplied to the plurality of cleaning nozzles 52 through the cleaning-liquid supply line 53. The plurality of cleaning nozzles 52 are arranged along the longitudinal direction of the upstream-side nozzle cover 41 and the downstream-side nozzle cover 42. Specifically, some of the plurality of cleaning nozzles 52 are arranged below the upstream-side nozzle cover 41, and the rest of the plurality of cleaning nozzles 52 are arranged below the downstream-side nozzle cover 42.

FIG. 21 is a diagram showing the plurality of cleaning nozzles 52 when emitting the cleaning liquid onto the inner surfaces of the upstream-side nozzle cover 41 and the downstream-side nozzle cover 42. The cleaning liquid is emitted from below toward the upstream-side nozzle cover 41 and the downstream-side nozzle cover 42. The inner surfaces of the upstream-side nozzle cover 41 and the downstream-side nozzle cover 42 are cleaned with the cleaning liquid, so that the polishing debris and the slurry adhering to the inner surfaces of the upstream-side nozzle cover 41 and the downstream-side nozzle cover 42 are washed away with the cleaning liquid.

FIG. 22 is a top view showing still another embodiment of the non-contact pad cleaning apparatus. Configurations of this embodiment which are not particularly described are the same as those of the embodiment described with reference to FIGS. 1 to 4, and therefore redundant description thereof will be omitted. The non-contact pad cleaning apparatus further includes a cover-outer-surface cleaning device 61 configured to clean the outer surfaces of the upstream-side nozzle cover 41 and the downstream-side nozzle cover 42. The cover-outer-surface cleaning device 61 includes a plurality of cleaning nozzles 62 arranged radially outward of the rotary table 5, and a cleaning-liquid supply line 63 coupled to these cleaning nozzles 62. The cleaning-liquid supply line 63 is coupled to a cleaning-liquid supply source (not shown).

Cleaning of the upstream-side nozzle cover 41 and the downstream-side nozzle cover 42 is performed after cleaning of the polishing surface 2a of the polishing pad 2 performed by the non-contact pad cleaning apparatus is finished. Specifically, as shown in FIG. 23, the nozzle oscillation mechanism 38 moves the polishing-surface cleaning device 8 from a position above the polishing surface 2a to a position below the plurality of cleaning nozzles 62. The plurality of cleaning nozzles 62 are located higher than the upstream-side nozzle cover 41 and the downstream-side nozzle cover 42. A cleaning liquid (e.g., pure water, or a chemical liquid, or a combination thereof) is supplied to the plurality of cleaning nozzles 62 through the cleaning-liquid supply line 63. The plurality of cleaning nozzles 62 are arranged along the longitudinal direction of the upstream-side nozzle cover 41 and the downstream-side nozzle cover 42. Specifically, some of the plurality of cleaning nozzles 62 are arranged above the upstream-side nozzle cover 41, and the rest of the plurality of cleaning nozzles 62 are arranged above the downstream-side nozzle cover 42.

FIG. 24 is a diagram showing the plurality of cleaning nozzles 62 when emitting the cleaning liquid onto the outer surfaces of the upstream-side nozzle cover 41 and the downstream-side nozzle cover 42. The cleaning liquid is emitted from above toward the upstream-side nozzle cover 41 and the downstream-side nozzle cover 42. The outer surfaces of the upstream-side nozzle cover 41 and the downstream-side nozzle cover 42 are cleaned with the cleaning liquid, so that the polishing debris and the slurry adhering to the outer surfaces of the upstream-side nozzle cover 41 and the downstream-side nozzle cover 42 are washed away with the cleaning liquid.

In one embodiment, as shown in FIG. 25, the plurality of cleaning nozzles 62 may be fixed to the nozzle carrier 35 by a nozzle holder 65. The plurality of cleaning nozzles 62 face the outer surfaces of the upstream-side nozzle cover 41 and the downstream-side nozzle cover 42. By discharging the cleaning liquid toward the upstream-side nozzle cover 41 and the downstream-side nozzle cover 42 from above, the outer surfaces of the upstream-side nozzle cover 41 and the downstream-side nozzle cover 42 can be cleaned. According to this embodiment, the cleaning of the upstream-side nozzle cover 41 and the downstream-side nozzle cover 42 can be performed not only after the cleaning of the polishing surface 2a of the polishing pad 2 by the non-contact pad cleaning apparatus is finished, but also during the cleaning of the polishing surface 2a of the polishing pad 2 by the non-contact pad cleaning apparatus.

The embodiments described with reference to FIGS. 2 to 25 can be combined as appropriate. For example, the embodiment described with reference to FIG. 7 is applicable to other embodiments. The cover-inner-surface cleaning device 51 described with reference to FIGS. 19 to 21 and/or the cover-outer-surface cleaning device 61 described with reference to FIGS. 22 to 25 may be combined with each of the embodiments described with reference to FIGS. 10 to 18. Further, both the cover-inner-surface cleaning device 51 and the cover-outer-surface cleaning device 61 may be provided.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A non-contact pad cleaning apparatus for cleaning a polishing surface of a polishing pad for polishing a workpiece in a non-contact manner, comprising:
a rotary table configured to rotate the polishing pad;
a polishing-surface cleaning device having a plurality of two-fluid nozzles each configured to emit a two-fluid jet toward the polishing surface of the polishing pad; and
a liquid supply line and a gas supply line coupled to the plurality of two-fluid nozzles,
wherein the polishing-surface cleaning device comprises:
the plurality of two-fluid nozzles having a plurality of ejection ports, respectively, the plurality of ejection ports being configured to emit the two-fluid jet;
a nozzle carrier holding the plurality of two-fluid nozzles; and
an upstream-side nozzle cover and a downstream-side nozzle cover fixed to the nozzle carrier,
wherein the plurality of ejection ports are arranged at different distances from a center of the polishing pad,
the upstream-side nozzle cover is arranged upstream of the plurality of two-fluid nozzles in a rotation direction of the polishing pad,
the downstream-side nozzle cover is arranged downstream of the plurality of two-fluid nozzles in the rotation direction of the polishing pad, and
a distance from the polishing surface to a lower end of the upstream-side nozzle cover is larger than a distance from the polishing surface to a lower end of the downstream-side nozzle cover.

2. The non-contact pad cleaning apparatus according to claim 1, wherein the distance from the polishing surface to the lower end of the upstream-side nozzle cover is in a range of 10 mm to 20 mm.

3. The non-contact pad cleaning apparatus according to claim 1, wherein the distance from the polishing surface to the lower end of the downstream-side nozzle cover is in a range of 3 mm to 9 mm.

4. The non-contact pad cleaning apparatus according to claim 1, wherein an outer end portion of the upstream-side nozzle cover and an outer end portion of the downstream-side nozzle cover are located radially outward of a peripheral edge of the polishing pad.

5. The non-contact pad cleaning apparatus according to claim 1, wherein the polishing-surface cleaning device further includes an outer cover coupled to an outer end portion of the upstream-side nozzle cover and an outer end portion of the downstream-side nozzle cover.

6. The non-contact pad cleaning apparatus according to claim 1, wherein the polishing-surface cleaning device further includes an inner cover coupled to an inner end portion of the upstream-side nozzle cover and an inner end portion of the downstream-side nozzle cover.

7. The non-contact pad cleaning apparatus according to claim 1, wherein a width of the upstream-side nozzle cover in a direction perpendicular to a longitudinal direction of the nozzle carrier is larger than a width of the downstream-side nozzle cover in the direction perpendicular to the longitudinal direction of the nozzle carrier.

8. The non-contact pad cleaning apparatus according to claim 1, wherein each of the plurality of ejection ports is parallel to a longitudinal direction of the nozzle carrier.

9. The non-contact pad cleaning apparatus according to claim 1, further comprising a nozzle oscillation mechanism configured to oscillate the polishing-surface cleaning device above the polishing pad.

10. The non-contact pad cleaning apparatus according to claim 9, further comprising an operation controller configured to control an operation of the nozzle oscillation mechanism,
wherein the operation controller is configured to instruct the nozzle oscillation mechanism to oscillate the polishing-surface cleaning device above the polishing pad at a preset oscillation angle, and
the preset oscillation angle is changeable.

11. The non-contact pad cleaning apparatus according to claim 1, wherein the upstream-side nozzle cover is inclined downward toward an upstream side in the rotation direction of the rotary table, and
the downstream-side nozzle cover is inclined downward toward a downstream side in the rotation direction of the rotary table.

12. The non-contact pad cleaning apparatus according to claim 1, wherein the plurality of ejection ports are inclined at different angles with respect to a longitudinal direction of the nozzle carrier.

13. The non-contact pad cleaning apparatus according to claim 12, wherein the plurality of ejection ports are located on a plurality of straight lines, respectively, passing through the center of the polishing pad when viewed from above the polishing pad.

14. The non-contact pad cleaning apparatus according to claim 1, further comprising a cover-inner-surface cleaning device configured to clean inner surfaces of the upstream-side nozzle cover and the downstream-side nozzle cover.

15. The non-contact pad cleaning apparatus according to claim 1, further comprising a cover-outer-surface cleaning device configured to clean outer surfaces of the upstream-side nozzle cover and the downstream-side nozzle cover.
